(19) United States
(12) Patent Application Publication
(10) Pub. No.: US 2014/0360086 A1
(43) Pub. Date: Dec. 11, 2014

(54) FISHING ROD HOLDER

(71) Applicant: Steven Mark Finlan, Arlington, WA (US)

(72) Inventor: Steven Mark Finlan, Arlington, WA (US)

(21) Appl. No.: 14/298,724

(22) Filed: Jun. 6, 2014

Related U.S. Application Data
(60) Provisional application No. 61/831,978, filed on Jun. 6, 2013.

(51) Int. Cl. A01K 97/10

(52) U.S. Cl. CPC A01K 97/10
USPC 43/21.2

(57) ABSTRACT

A fishing rod holder 10 includes a tubular receiver 18 for receiving a fishing rod and reel. The receiver 18 includes a longitudinal slot 26 extending downwardly from an open top 22 to intersect with a transverse slot 28. The transverse slot includes curved upper edges 34 that form hooks 36 at the intersection of the slot ends 32 and the slot upper edges 34 thereby to capture the arm of a fishing reel therein to retain the fishing reel and associated fishing rod within the holder.

### CROSS-REFERENCE(S) TO RELATED APPLICATION(S)

This application claims the benefit of Provisional Application No. 61/831978, filed Jun. 6, 2013, and is incorporated herein by reference in its entirety.

### FIELD OF THE INVENTION

The present invention pertains to fishing equipment, and more particularly to a fishing rod holder for holding and supporting the fishing rod, including while baiting a hook or carrying out other activities.

### BACKGROUND

Numerous activities are typically carried out during fishing with the fishing line removed from the water. These activities include, for example, baiting a hook, replacing or changing a lure, untangling the fishing line, removing a hook from a caught fish, releasing a fish, etc. Typically these are activities requiring that the fisherman hold the rod while performing such activities. Fishermen may hold the rod under an arm, between the legs, or otherwise. However, it is often difficult to hold the rod at a convenient angle when carrying out the aforementioned activities. Also, because the fisherman is holding the rod with his/her arm(s), performing the above activities may be cumbersome or at least awkward, especially in less than ideal weather conditions. The present invention provides a fishing rod holder that conveniently holds the rod, together with the reel attached thereto, thereby freeing the hands of the fisherman to more conveniently perform the foregoing activities.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

A fishing rod holder for holding a fishing rod and associated reel mounted on the fishing rod includes a tubular-shaped receiver having an interior size sufficient to receive the butt portion of a fishing rod and associated reel. The receiver has an open first or upper end and a first longitudinal slot extending downwardly from the upper end to intersect with a first lower horizontal or transverse slot. The width of the longitudinal slot is sufficiently wide to receive the leg of the fishing reel which bottoms against the bottom side of the longitudinal slot when the fishing rod and reel are fully positioned within the receiver.

The transverse slot includes a bottom side edge that is opposite to or distal from the receiver open first end. This side edge of the transverse slot is not linear or flat, but extends upward toward the receiver open end at a location intermediate the ends of the first transverse slot. Accordingly, the ends of the first transverse slot are at an elevation below the intermediate portion of the first transverse slot. In this regard, the distal side edge of the first transverse slot curves away from the receiver open first end in the direction toward the ends of the first transverse slot. As such, the transverse slot distal side edge defines depression or wells at the ends of the transverse slot, thereby to induce the fishing reel arm to remain at one end of the first transverse slot and adjacent or against the corresponding end of the first transverse slot.

Further, the first transverse slot defines upper or proximal side edges extending along the first transverse slot, opposite to the distal side edge of the first transverse slot. Such proximal side edges of the transverse slot intersect the adjacent sides of the longitudinal slot. Further, the proximal side edges of the first transverse slot extend downwardly or toward the distal side edge of the first transverse slot as the proximal side edges approach the adjacent side edges of the first longitudinal slot. Accordingly, the proximal side edges define hooks in conjunction with the end edges of the first transverse slot. Such hooks facilitate retaining the reel within the transverse slot if a lifting force is applied to the fishing rod and reel seeking to remove the rod and reel from the holder when it is the intention of the fisherman to retain the fishing rod and associated reel within the holder.

In accordance with the present disclosure, the fishing rod holder includes a second longitudinal slot extending downwardly from the open first end of the receiver. The second longitudinal slot is located diametrically opposite the first longitudinal slot. The fishing rod holder also includes a second transverse slot that intersects the second longitudinal slot at a location along the second longitudinal slot spaced from the first end of the receiver. The second transverse slot extends beyond the width of the second longitudinal slot. The second longitudinal slot and second transverse slot are sized to receive the arm or other portion of a bait-casting type reel therein.

The fishing rod holder also includes a mounting structure for supporting the receiver in generally upright position with the first, open end of the receiver positioned above the first transverse slot. Such mounting structure can be constructed to be wearable by a fisherman. In this regard, the mounting structure can include a belt that is extendable around the waist of the fisherman.

In accordance with a further aspect of the present disclosure, the mounting structure can include a stand for positioning the receiver in a desired location. Such location may include, for example, a dock, a pier, a boat, or other location.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a front elevational view of the fishing rod holder of the present disclosure;

FIG. 2 is a rear elevational view of FIG. 1;

FIG. 3 is a view similar to FIG. 1 showing a fly rod and reel being held by the fishing rod holder of the present disclosure;

FIG. 4 is a view similar to FIG. 3, but showing a spinning rod and reel being held by the holder of the present disclosure;

FIG. 5 is an elevational view showing a bait-casting rod and reel held by the fishing rod holder of the present disclosure; and

FIG. 6 is a side elevational view of a fishing rod holder supported by a mounting structure mountable to a fixed location.

### DETAILED DESCRIPTION

The detailed description set forth below in connection with the appended drawings, where like numerals reference like elements, are intended as a description of various embodiments of the disclosed subject matter and are not intended to represent the only embodiments. Each embodiment described in this disclosure is provided merely as an example or illustration and should not be construed as preferred or advantageous over other embodiments. The illustrative examples provided herein are not intended to be exhaustive or to limit the disclosure to the precise forms disclosed. Similarly, any steps described herein may be interchangeable with other steps, or combinations of steps, in order to achieve the same or substantially similar result.

In the following description, numerous specific details are set forth in order to provide a thorough understanding of exemplary embodiments of the present disclosure. It will be apparent to one skilled in the art, however, that many embodiments of the present disclosure may be practiced without some or all of the specific details. In some instances, well known process steps have not been described in detail in order not to unnecessarily obscure various aspects of the present disclosure. Further, it will be appreciated that embodiments of the present disclosure may employ any combination of features described herein.

The present application may include references to directions, such as “forward,” “rearward,” “front,” “back,” “upward,” “downward,” “right hand,” “left hand,” “in,” “out,” “extended,” “advanced,” “retracted,” “proximal,” “distal,” “central,” etc. These references and other similar references in the present application are only to assist in helping describe and understand the present invention and are not intended to limit the present invention to these directions or locations.

The present application may also reference quantities and numbers. Unless specifically stated, such quantities and numbers are not to be considered restrictive, but exemplary of the possible quantities or numbers associated with the present application. Also in this regard, the present application may use the term “plurality” to reference a quantity or number. In this regard, the term “plurality” is meant to be any number that is more than one, for example, two, three, four, five, etc.

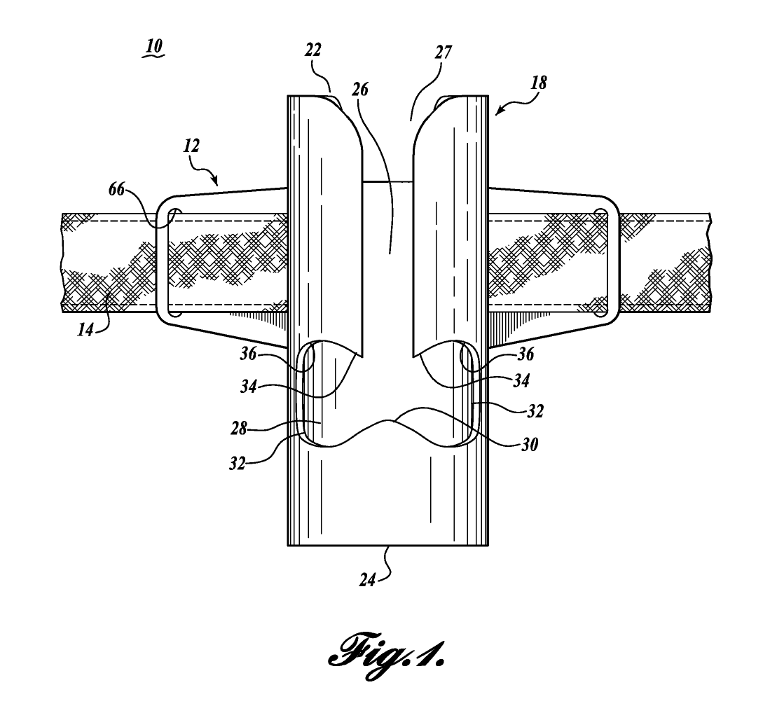

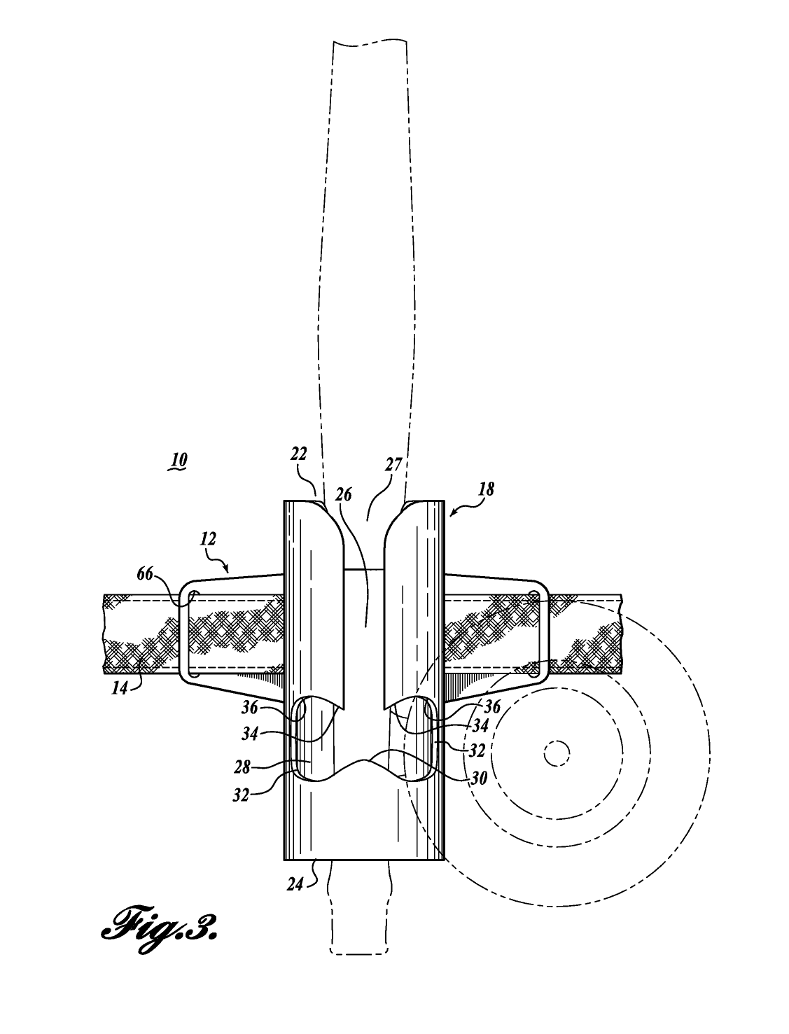

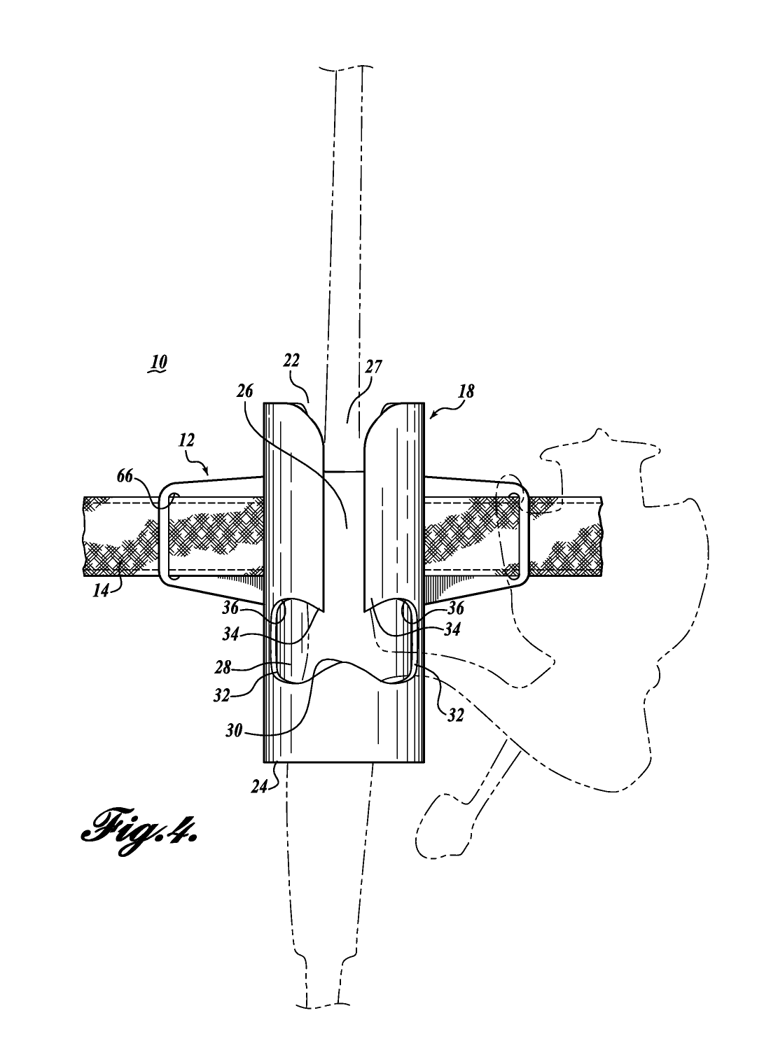

Referring initially to FIGS. 1-5, fishing rod holder 10 of the present disclosure is illustrated as attached to a belt clip 12 engaged with a belt 14 which is extendable around the waist of a fisherman. The holder 10 includes a tubular-shaped receiver 18 that can be attached to the clip 12 by any convenient means, such as by the use of hardware members 20, such as rivets, or other mechanical fasteners. Alternatively, the receiver may be glued or otherwise adhered or fused to the belt clip 12.

The receiver 18 is tubular in shape having an open top 22 and an open bottom 24. A longitudinal slot 26 extends downwardly from the top 22 along a majority of the length of the receiver to intersect a transverse or horizontal slot 28 located near the bottom 24 of the receiver. The transverse slot 28 extends beyond the width of the longitudinal slot 26. The longitudinal slot 26 is shown as being of substantially constant width. A curved lead-in 27 is formed at the top of the slot 26 to facilitate receiving into the slot the arm or other portion of a fishing reel.

The transverse slot 28 includes a distal side edge 30 along the bottom of the slot, which is the side of the transverse slot that is distal from the longitudinal slot 26. Such slot side edge 30 is crowned at its center and slopes (curves) downwardly toward the ends 32 of the transverse slot. The upper or top side edges 34 of the transverse slot are not horizontal, but rather from the ends 32 of the slot slope downwardly toward the slot side edge 30 as the slot upper edges extend inwardly toward the longitudinal slot 26. In this manner, the slot top edges 34 form a hook 36 at the intersection of the slot top edges 34 and the slot end edges 32. As described below, such hooks 36 help retain the fishing rod, with the attached reel engaged with the holder 10.

In use with a fly rod and reel or a spinning rod and reel, the handle or butt of the rod is simply lowered into the holder 10 so that the reel arm enters longitudinal slot 26 and slides down through the slot to bottom against the transverse slot bottom side edge 30. At that point, the rod and attached reel can be rotated in the holder so that the reel arm abuts against one of the ends 32 of the transverse slot 28. The crowned bottom side edge 30 of the slot 28 facilitates the rotation of the rod and reel, and tends to keep the arm of the reel positioned against one of the slot ends 32. Also, if the fisherman bends over or the rod and reel are shifted or lifted upwardly relative to the holder 10, the arm of the reel will catch against one of the hooks 36 formed in the upper edge of the transverse slot, thereby to retain the rod and reel engaged within the holder.

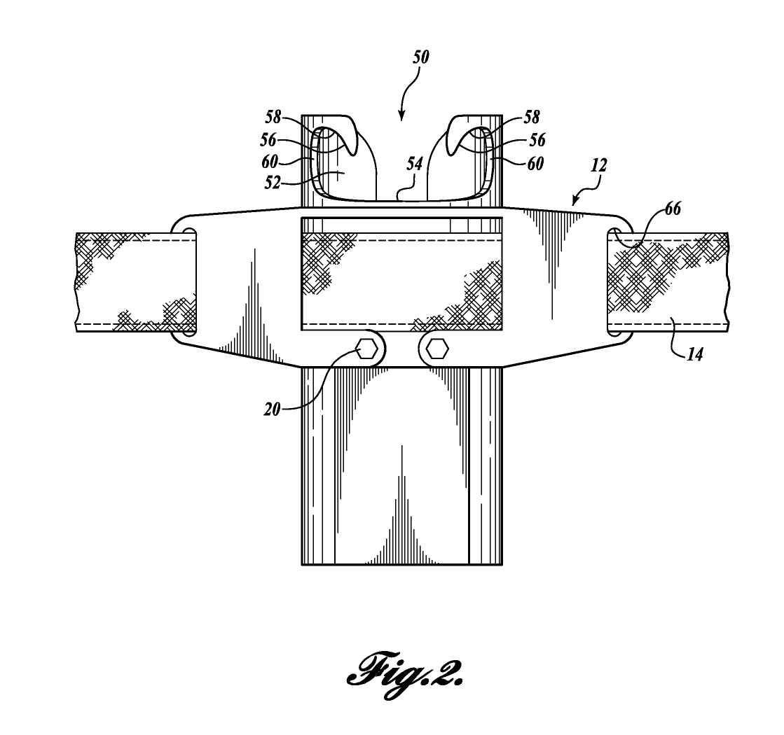

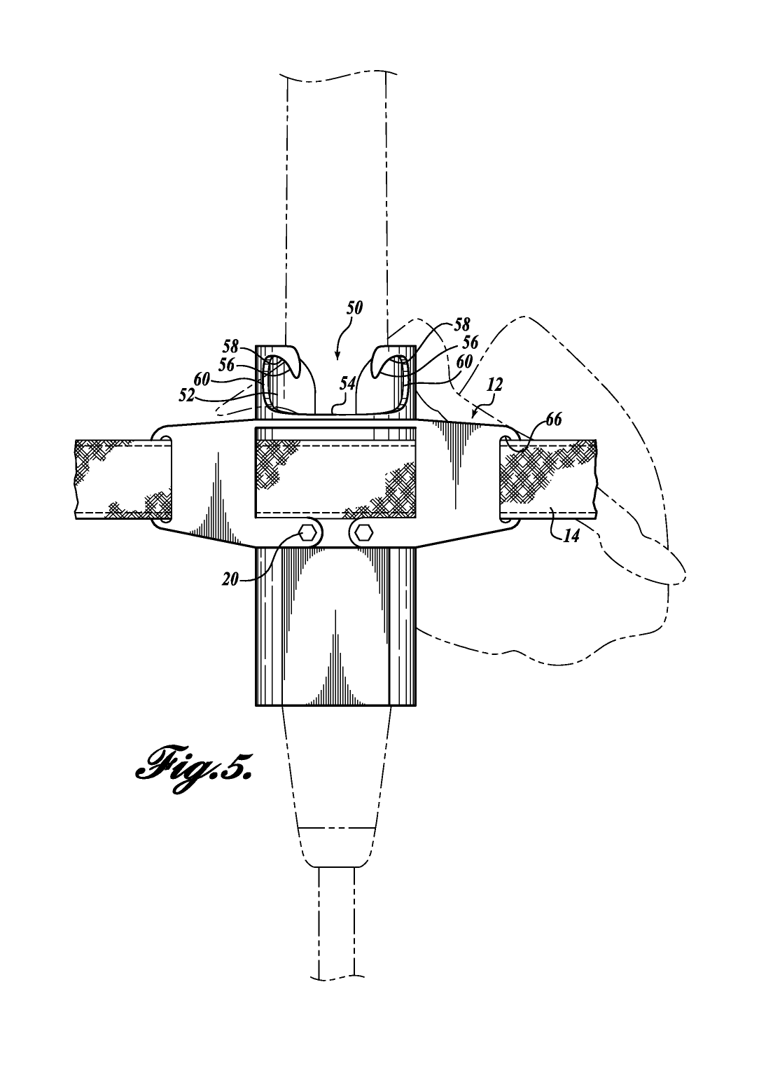

The holder 10 is also configured to hold and retain bait/casting rods and associated reels, seen in particular in FIGS. 2 and 5. In this regard, the holder 10 includes a second longitudinal slot 50 extending downwardly from the open top 22 at a location diametrically opposite to the first longitudinal slot 26. The second slot 50 does not extend downwardly very far before it intersects with a second transverse slot 52. The second transverse slot 52 can be shaped similarly to the first transverse slot 28. In this regard, the second transverse slot 52 includes a slot bottom side edge 54 extending along the slot distal from the longitudinal slot 50 and also distal from the open top 22. The slot bottom side edge 54 is shown as being substantially horizontal, but can be crowned in the manner of slot bottom side edge 30 discussed above. The transverse slot 52 also includes top edges 56 that are shaped similar to slot top edges 34 described above thereby to define hooks 58 at the intersection of the slot top edge 56 and slot end edges 60. In this manner, the longitudinal slot 50 and transverse slot 52 function in a manner similarly to longitudinal slot 26 and related transverse slot 28. In this regard, the arm of the casting reel engages downwardly into the longitudinal slot 50 and then the reel and rod are rotated so that the reel arm is positioned against one of the end walls 60 of a transverse slot. It will be appreciated that once in this position, the hooks 58 assist in retaining the casting reel together with the casting rod engaged within the holder 10.

The holder 10 may be mounted to be worn by a fisherman, or may be mounted to a boat, pier, dock, or other convenient location. FIGS. 1-4 illustrate the holder 10 as adapted to be worn by a fisherman. In this regard, as described above, the holder 10 is attached to a belt clip 12. The belt clip 12 includes slots 66 for receiving the belt 14 therethrough. The belt 14 can be fitted with a buckle, clasp, or other means for connecting the ends of the belt and retaining the belt securely around the waist of the fisherman. It will be appreciated that more than one holder 10 can be mounted on belt 14 so that the fisherman can support two or more rods and reels at the same time. It is not unusual for a fisherman to carry more than one rod and reel at a time.

Although not illustrated, the holder 10 may be spaced outwardly from the clip 12 by use of a spacer. The belt clip 12 is shown as generally planar, but can be formed with a curvature or contour to generally match the curvature of the body of a fisherman. Also, it will be appreciated that the size and shape of the belt clip can be altered so as to provide a desired amount of bearing area against a fisherman based on, for example, the size of the fishing rod being held by the holder.

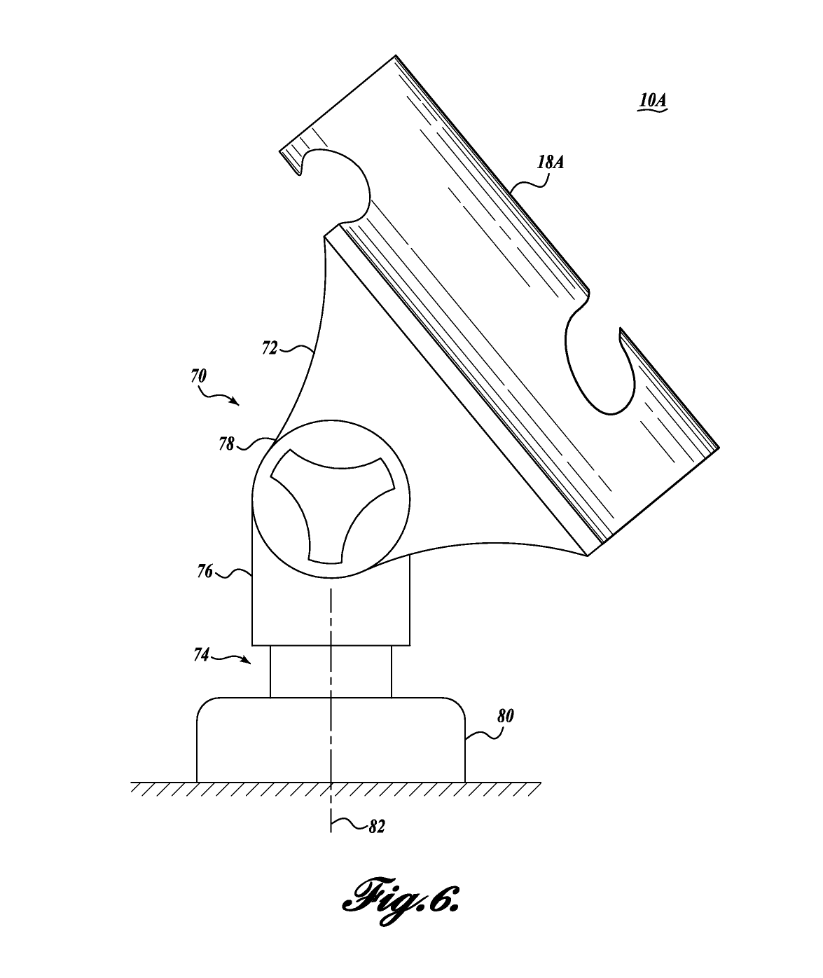

FIG. 6 illustrates the holder 10A mounted on a mounting structure 70 for positioning the holder on a boat, pier, dock, or other location. The mounting structure 70 includes an upper saddle 72 to which the receiver 18A of holder 10A is mounted. The saddle 72 is pivotally connected to a stand 74 having an upper mounting ear 76 for engaging with saddle 72. A rotatable locking head 78 may be used to both attach the saddle 72 to the mounting ear 76 and hold the saddle 72 in desired orientation relative to the rotational axis of the mounting ear 76. Also, the mounting ear 76 may be configured to be rotatable relative to mounting base 80 about upright axis 82. Means may be provided to retain the mounting ear 76 in a desired orientation about axis 82 relative to the mounting base 80.

Of course, other structures and systems may be provided to mount the holder 10A than as shown in FIG. 6. Nonetheless, the holder 10a provides the same functionality and advantages provided by holder 10A described above.

In one specific but not limiting form of the present disclosure, the holder 10 may be constructed from a tubular-shaped receiver 18 with an internal diameter of about 1½ inches. This internal diameter of receiver 18 is large enough to fit most common fishing rods. However, it is to be understood that the internal diameter of receiver 18 can be smaller or larger to match the size of the handle/butt portion of the fishing rod being used.

Moreover, in one non-limiting embodiment of the present disclosure, the tubular receiver 18 may be approximately 5 inches in length. Of course, the tubular receiver 18 can be of other lengths, to correspond to or match the length of the fishing rod being held by the holder.

The longitudinal slot can 26 can extend down from the top 22 of the receiver a distance of about three inches before intersecting the transverse slot 28. The width of the longitudinal slot can be about ¾ inch, but can be of other widths to correspond to the size and/or construction of the reel. Also, the curved lead-in 27 can extend down from the top 22 for about ½ inch.

Likewise, the dimensions of the transverse slots 28 and 52 can be tailored to a particular fishing reel. In this regard, the width of the slots 28 and 52 can be about 1 inch, or can be larger or smaller than this dimension. Moreover, the horizontal length of the transverse slot can also be varied as desired. For example, the transverse slot can extend to about ½ of the circumference of the tubular receiver 18.

It will be appreciated that the present fishing rod holder can free the hands of the fisherman for performing numerous tasks as noted above. Also, because the fisherman does not have to set his/her rod down to perform such tasks, there is less likelihood that the rod would be damaged, such as by stepping on the rod or reel, by snapping the tip of the rod, by stepping on and thereby crushing an eyelet, getting dirt or sand in the reel, or having the rod and reel fall off a boat, a dock or a pier and into the water.

Also, it will be appreciated that the fishing rod holder of the present disclosure can be used with many different types of fishing rods and reels, including, but not limited to, fly rods and reels, casting rods and reels, and spinning rods and reels.

While illustrative embodiments have been illustrated and described, it will be appreciated that various changes can be made therein without departing from the spirit and scope of the invention. For example, the slot 26 in the receiver 18 can be formed to initially narrow from top 22 along the length of the receiver reaching a minimum width intermediate the ends of the slot and then widen as the slot 26 extends further downwardly towards its intersection with transverse slot 28. The wider portion of the slot at the top 22 can serve as a convenient lead-in for a fishing reel arm, while the reduction in width of the slot reduces the likelihood that the fishing pole, with the attached reel, will inadvertently detach from the holder 10.

Also, although the receiver is shown as generally circular in cross-section, the receiver can be of other cross-sectional shapes such as triangular, square, oval, or elliptical.

The embodiments of the invention in which an exclusive property or privilege is claimed are defined as follows:

1. A fishing rod holder for holding a fishing rod and an associated reel mounted on the fishing rod, comprising a tubular-shaped receiver, said receiver comprising:
(a) an interior of sufficient size to receive the butt portion of the fishing rod with a reel mounted to the rod;
(b) an open first end;
(c) a first longitudinal slot extending from the open first end lengthwise of the receiver, said longitudinal first slot sized to receive the leg of the fishing reel; and
(d) a first transverse slot intersecting the first longitudinal slot, said first transverse slot sized to receive the leg of the fishing reel.

2. The fishing rod holder according to claim 1, wherein the tubular-shaped receiver comprises an open second end at the opposite end of the receiver from the open first end.

3. The fishing rod holder according to claim 1, wherein the width of the first longitudinal slot varies along its length.

4. The fishing rod holder according to claim 3, the first longitudinal slot defines a minimum width at a location intermediate the first open end of the receiver and the location that the first longitudinal slot intersects the first transverse slot.

5. The fishing rod holder according to claim 1, wherein the first transverse slot defines a side edge distal from the receiver open first end, said distal slot side edge extends toward the receiver open first end at a location intermediate the ends of the first transverse slot.

6. The fishing rod holder according to claim 5, wherein the distal side edge of the first transverse slot curves away from the receiver open first end in the direction towards the ends of the first transverse slot.

7. The fishing rod holder according to claim 5, wherein the first transverse slot defines proximal side edges extending along the first transverse slot opposite the distal side edge of the first transverse slot, said proximal side edges of the first transverse slot intersecting the adjacent sides of the longitudinal slot.

8. The fishing rod holder according to claim 7, wherein the proximal side edges of the first transverse slot extend toward the distal side edge of the first transverse slot as the proximal side edges approach the adjacent side edges of the first longitudinal slot.

9. The fishing rod holder according to claim 1, wherein the first transverse slot intersects the end of the first longitudinal slot opposite the open first end of the receiver.

10. The fishing rod holder according to claim 9, wherein the first transverse slot defines a side edge distal from the longitudinal slot, said distal slot side edge extends toward the longitudinal slot at a location intermediate the ends of the first transverse slot.

11. The fishing rod holder according to claim 10, wherein the distal side edge of the first transverse slot curves away from the longitudinal slot in the direction towards the ends of the first transverse slot.

12. The fishing rod holder according to claim 9, wherein the first transverse slot defines proximal side edges along the first transverse slot opposite the distal side edge of the first transverse slot, said proximal side edges of the first transverse slot extending toward the distal side edge of the first transverse slot as the proximal side edges approach the adjacent side edges of the first longitudinal slot.

13. The fishing rod holder according to claim 1, further comprising a second longitudinal slot extending from the open first end of the receiver lengthwise of the receiver and positioned diametrically opposite the first longitudinal slot.

14. The fishing rod holder according to claim 13, further comprising a second transverse slot intersecting the second longitudinal slot at a location along the second longitudinal slot spaced from the first end of the receiver, said second transverse slot extending beyond the width of the second longitudinal slot.

15. The fishing rod holder according to claim 14, wherein said second transverse slot having proximal side edges that intersect the adjacent sides of the second longitudinal slot.

16. The fishing rod holder according to claim 15, wherein the proximal side edges of the second transverse slot extend away from the first end of the receiver as the proximal side edges of the second transverse slot extend toward the adjacent sides of the second longitudinal slot.

17. The fishing rod holder according to claim 1, further comprising a mounting structure for supporting the receiver in generally upright position with the first open end of the receiver positioned above the first transverse slot.

18. The fishing rod holder according to claim 17, wherein said mounting structure is constructed to be wearable by a fisherman.

19. The fishing rod holder according to claim 18, wherein the mounting structure comprises a belt extendible around the waist of a fisherman.

20. The fishing rod holder according to claim 17, wherein said mounting structure comprises a stand for positioning the receiver in a desired location.
